(19) United States
(12) Patent Application Publication
(10) Pub. No.: US 2010/0218369 A1
(43) Pub. Date: Sep. 2, 2010

(54) CABLE HARNESS PRODUCTION SYSTEM

(76) Inventor: Dirk Selbach, Rottendorf (DE)

Correspondence Address: EDWIN D. SCHINDLER, FIVE HIRSCH AVENUE, P.O. BOX 966, CORAM, NY, 11727-0966, US

(21) Appl. No.: 12/677,102

(22) PCT Filed: Aug. 30, 2008
(86) PCT No.: PCT/DE08/01464

§ 371 Date: May 13, 2010

(30) Foreign Application Priority Data
Sep. 6, 2007 (DE) 20-2007-012-534.8

(51) Int. Cl. B23P 19/00

(52) U.S. Cl. 29/700

(57) ABSTRACT

A cable harness production system for producing a cable harness includes at least one elongated substantially vertical post that can be fixed to a foot on a bearing plate and, which carries on the tip thereof, either a receiving element for receiving a functional element connected to the cable harness or a cable laying aid for directly guiding the cable harness. The receiving element or the cable laying aid can be mounted onto the tip and the form of the tip is complementary to that of a recess on the lower side of the receiving element or the lower side of the cable laying aid.

The invention relates to a cable harness production system for producing a cable harness, consisting of at least one elongated, approximately vertical post that can be fixed to a foot on an installation plate, and carries, on the tip thereof, either a receptacle for receiving a functional element connected to the cable harness, or a cable laying aid for directly guiding the cable harness.

A cable harness is a length of cables that transmit signals for information, or electrical power for energy supply. By the term “cable” here is meant, besides wires of copper, aluminium, or other metals, sheathed with insulating material, also coaxial cables, hollow waveguides and optical waveguide cables, such as glass fibre cables or else steel twisted cables. The cables are held together by means of clips, cable straps, conduits or similar means and the finished cable harness connects together a plurality of functional elements such as plugs, connectors, switches or lights. The form of the cable harness is often to be adapted to specific spatial requirements on installation.

Numerous cable harnesses are used in automotive engineering, but also for electrical equipment, and those used, for example, in cars according to the state of the art can contain cable with a total length of several kilometres. Due to possible variants of the electrical equipment, a number of different cable harnesses are necessary even for vehicles that are otherwise the same or for the same devices.

The cables are assembled on a special workbench or on an installation board to form a cable harness, clamped together, wound or otherwise mechanically joined and electrically connected at their end points to the functional elements. In the prior art, the functional elements are retained in the receptacles of mounting stations and arranged on the installation plate, and cable laying aids are arranged on the installation plate for guiding and angling the cables. In the simplest case, pins are used, which are partly driven into the installation plate; in the prior art, however, usually column-like elements are used, which support a fork or a guide angle as receptacle. The cable harness rests on the fork and a functional element in a cable harness rests on the receptacle.

The reason for the elevated arrangement of the functional elements is that tools must in some cases act from a multiplicity of sides of the functional element or that holding clips are to be plugged onto the cable harness. For this, intervention from the underside is necessary. If the cable harnesses are to be wound with textile tape, the tape roll must be repeatedly guided around the cable.

Other necessary processing steps include the threading of wires into conduits or the attachment of contacts to the lines, in particular the connecting of one contact to two lines and the fitting of conduits one inside the other.

In the prior art, various variants of cable harness production systems exist, and even functional elements that are adapted to the production equipment of a cable harness production system. Thus, e.g. U.S. Pat. No. 5,945,635, Coutaro Suzuki describes a special cable joiner that rests in receptacles on a columnar post.

Here, it is known that each columnar mounting station consists of a post, which is fixed downwardly via a foot on the installation plate and at its upper end bears a receptacle for a functional element or a cable laying aid. Both the receptacle and cable laying aids are required in a multiplicity of variants.

By virtue of the large number of possible variations in the electrical equipment of automobiles, washing machines or other equipment, a multiplicity of different variants of cable harnesses, which often differ in only a few points, are required for otherwise identical samples. An adapted cable system must be created for manufacturing each variant. Since, in the prior art, the foot and post are in each case firmly connected to the receptacle or to the cable laying aid, for each change the entire old unit must be removed and a new one fixed on the installation plate. The disadvantage is that the—actually unnecessary—change of foot and column increases the costs and prolong the working time for the change since, in general, at least two fixing screws must be released, secured and screwed in again.

Further disadvantageous restrictions to the new construction of cable harness production systems are that, at each point at which a step of the cable harness production is to be performed, not only feet and columns, which are always identical, must always be set up, but, simultaneously with this working step, also the—correct—choice of the particular fitting receptacle and the respecting fitting cable laying aid must be made.

Against this background, it is the object of the invention to create a cable harness production system that permits rapid construction of the feet and posts without taking into account the receptacle or cable laying aids that are subsequently necessary, and, in the event of modifications to the existing cable harness system, permits the rapid and material-saving exchange of receptacles and/or cable laying aids.

As a solution, the invention presents a cable harness production system in which the receptacle or the cable laying aid can be plugged onto the tip, and the shape of the tip is complementary to a recess on the underside of the receptacle or to the underside of the cable laying aid.

The gist of the invention consists in separating the formerly rigid connection between the receptacle or cable laying aid and the post. Only the foot and post are still firmly connected to one another. Receptacles or cable laying aids are now plugged Onto a standardized tip, which has a fitting, standardized counterpart as plug connection. The decisive advantage is that, in the case of a cable harness production system for slight changes, the foot and column do not have to be exchanged as well, but only the exchange of that receptacle or cable laying aid that is plugged thereon is necessary.

For the production of these tools as plastic parts, the required moulds are considerably smaller, since post and foot do not have to be integrally cast but can be produced from a different, frequently usable mould.

With an Increasing quantity of the posts, it becomes economical again to create variants of the post, that is to say posts of various heights or even to produce posts that are adjustable vertically or In the angle of inclination.

A further principle advantage of the invention is that a very long post can be produced, which, in use, can be adapted very precisely and infinitely variably to the respective required length, e.g. by sawing to length.

For connecting the post and the receptacles or cable laying aids that are to be plugged thereon, various variants are conceivable. It is appropriate to shape the tip as a profile section, wherein, as profile, in particular a triangle, a rectangle, a hexagon, another polygon, an oval, a circle, a star or a gear wheel are appropriate.

A circle has the advantage that the mounted receptacle can be rotated at any desired angle, however, without further fixture by external forces, such as, e.g., a clamping screw, can also be easily rotated unintentionally by external forces.

The other, aforementioned profile forms block rotation, but, in the case of a symmetrical profile, can be plugged in rotated in stages A regular hexagon, for example, thus permits six angular steps, that is to say rotated by 60° with respect to one another. An even finer resolution can be achieved by means of toothed wheel profiles, which are also known as splines. With an increasing number of teeth or notches, the number of different orientations that can be achieved by plugging them in increases.

If the height of the post is to be variable by sawing to length in situ, the profile of the post must extend uniformly and with parallel walls as far as the outermost tip.

If, however, only one single height of the post is necessary, the tip can also be oriented as a cone or truncated cone. The advantage of this arrangement is that the receptacles or cable laying aid centre themselves and can even be joined even more intensively to the posts by further pressing thereon.

Another alternative to joining between the post tip and the parts to be mounted is a bayonet connection, but only when the application does not require absolute rotational stiffness. In this case, in this connection as well as in other rotatable connections, a clamping screw is arranged perpendicularly to the longitudinal axis of the post, which firmly connects the tip to the part mounted thereon.

For the receptacles, all the forms known hitherto, as well as new variants, e.g. adapted to special functional elements of the cable harness, can be used. A very widespread and universally applicable form for a receptacle is a horizontal plate with one lateral edge. Depending on the application, there may also be two edges, which are arranged, e.g., at an angle to one another. Another suitable form for a receptacle is a channel. Or the receptacle is complementary to the outer dimensions of a functional element in the cable harness, such as, e.g., plugs, connectors, switches, a light, sensor or entire electronic module.

Another variant of the receptacle is an intermediate retainer, to which other, non-system-conformal receptacles or cable connectors can be fixed.

As a cable laying aid, in particular an upwardly open, approximately U-shaped fork is suitable. Also conceivable, however, is the curved section of a channel in particular for the forming of very narrow bending radii of a cable harness. These two forms of cable laying aids are examples of variants that only serve as a tool in the cable harness production system.

However, cable laying aids are also conceivable which also remain on the cable after removal of the finished cable harness from the cable harness production system. If they possess a system-conformal recess, with which they can be mounted directly on the tip 26 of the post, a recess is made unnecessary. Conceivable forms of such a cable laying aid are cable retainers, cable clips, cable fasteners, cable clamps, cable connectors, cable guide, cable bushes, conduits, winding tapes, cable glands, box seals, pull-tight seals or cable markers.

In the production of cable harnesses, there are many sources of error, so that the testing of the cable harness is a necessary part of its production. For such test purposes, receptacles can be electrically conductive and have a contact to a plug or an individual cable. It may be suitable to produce an electrically conductive connection from the receptacle via the post and the foot down to an electrically conductive layer of the connecting plate. By this means, via an adjacent, also completely electrically conductive post, an electrical circuit can be closed, which is useful for test purposes.

As a further equipment option, test means can be installed in the post, which operate e.g. mechanically or electrically. An example of this is a radio transmitter that transmits a test result wirelessly to a central test station.

For energy supply of such modules, an installation space or another installation means for an energy storage means and/or an energy converter can be integrated into at least one post. Examples of proven energy storage means are an accumulator, a capacitor and/or a battery. These storage means must be charge with the same form of energy that they output. When the storage means is empty, it can either be exchanged or recharged via an—even only short-term—energy supply. The connections necessary for this can be used for other purpose outside the charging times.

Energy Converters are another or additional means of energy supply. These converters can, e.g., branch off a small portion of the mechanical energy on insertion of an element onto a receptacle or into the cable laying aid and convert it into electrical energy, e.g. by means of a piezo element or a magnetic coil. Or a solar module converts daylight or the hail lighting into electrical supply energy.

In this manner, an electrical test means or another production means, can be supplied with energy even without a fixed connection to a power supply.

An alternative to supplying electrical energy is an installation plate, which is provided with two electrically conductive and mutually insulated layers. In this embodiment, a multiplicity of subvariants for producing an electrically conductive, two-pole connection via a foot, post and receptacle are possible.

It is appropriate to use the fastening means of the foot as an electrical connection. If the fastening means are screws, the first screw Must be long enough to penetrate the more proximate electrically conductive layer of the installation plate and short enough to be spaced from the second electrically conductive layer. At least one second screw must be longer than the first screw, specifically so long that it penetrates the more distant electrically conductive layer and is spaced from the first electrically conductive layer or is electrically insulated from it.

In this embodiment, the screws can be screwed in either from the populated side of the installation plate or from the unpopulated side. It is appropriate to countersink them in an electrically conductive layer. In all circumstances, the second, longer screw can have an insulating spacer on its shaft. The decisive advantage of this embodiment is that the fastening foot can be mounted at any desirable place of the plate.

However, if the posts can be arranged at the crossing points of a grid, it is an obvious step to provide the first electrically conductive layer with openings, through which the respective longer second screws can be passed without having contact with this layer.

Alternatively the foot can be designed such that it has a single stud, which serves as a central fastener in the installation plate. Such a stud can also be provided with two contacts insulated from one another, which in each case come into contact with the first and the second electrically conductive layer.

Further details and features of the invention are explained below in greater detail with reference to examples. However, they are not intended to limit the Invention but only explain it. In schematic view,

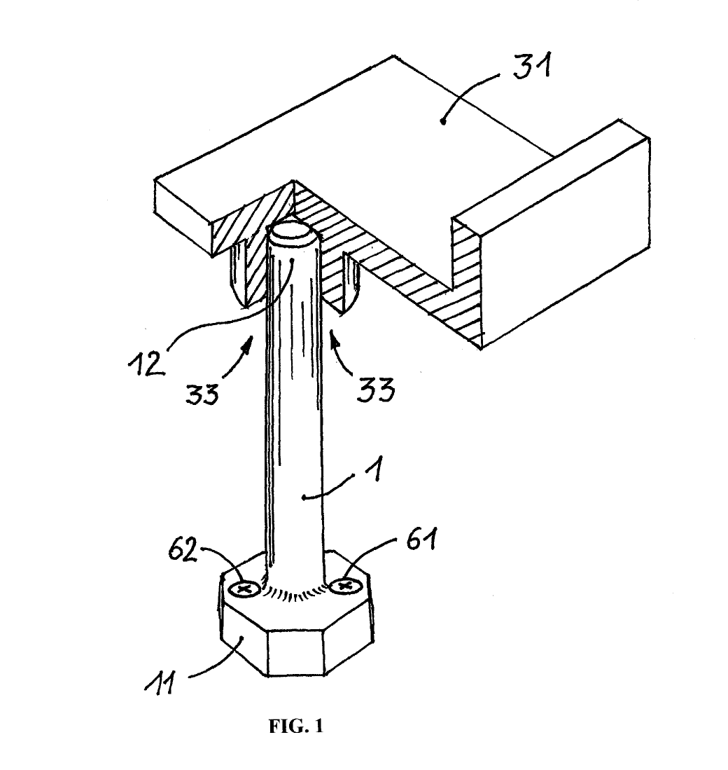

FIG. 1 shows a post 1 with receptacle 31

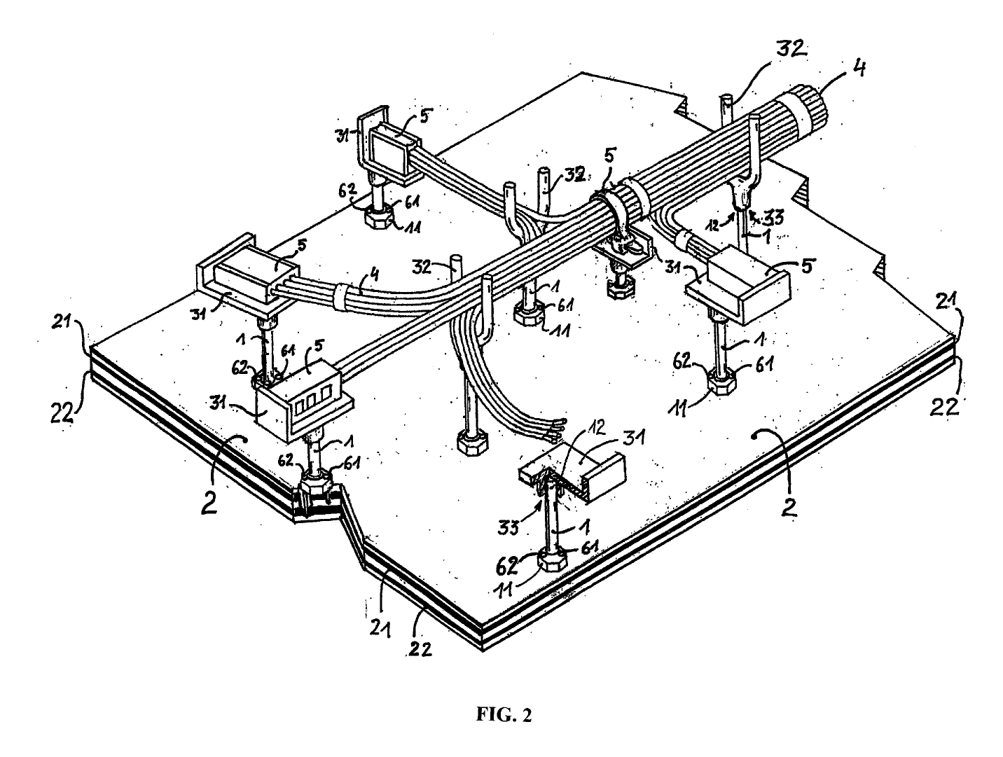

FIG. 2 cable harness production system with nine posts 1

In detail, the figures show:

FIG. 1 shows, as oblique view, a post 1 which, on its tip 12, bears a receptacle 31, which is shown cutaway at the front corner to reveal, on its underside, the recess 33, which is arranged over the tip 12 of the post 1.

In the example shown here, the post 1 has a circular profile. With this profile, the tip 12 engages in the also circular recess 33 on the underside of the receptacle 31.

In this example, the receptacle 33 is a bore in a cylindrical continuation on the otherwise flat underside of the receptacle.

The foot 11 on the underside of the post 1, in this example, has the screws 61 and 62 as fixture on the installation plate 2—which, is not shown here.

In FIG. 1 it is clearly understandable that the receptacle 31 is plugged onto the tip 12 of the post 1 and can simply be pulled off upwardly. Since, in the case of use from above, the load of the functional element—not shown here—rests on the receptacle 31, the receptacle 31 is reliably secured in its position on the tip 12 of the post 1.

FIG. 2 shows a perspective view of a section of a cable harness production system with a total of nine posts 1. Of these, the post 1 already shown in FIG. 1, having resting thereon a receptacle 31, which, in the drawing, is cut away at the front corner, can be recognised close to the front corner. The eight other posts 1 are also populated, specifically with five further receptacles 31, of which four bear, as functional element 5, one plug in each case at the end of a branch of the cable harness 4, and the receptacle 31 in the diagram centre bears a cable loop as functional element.

Furthermore, three cable laying aids 32 are drawn, in this case as U-shaped forks for guiding the cable harness 4. On the cable laying aid 32 shown at the top right, the thicknening can be seen at the meeting point of the two legs, within which the, in this case, bore-shaped recess 33 is introduced, with which the cable laying aid 32 is mounted on the tip 12 of the post 1.

In FIG. 2, it can be readily seen how the cable laying aids 32 are used for producing bends of the cable harness and how they support the cable harness at straight points. It can also be seen that the receptacles 31, which in this example are table-shaped with an edge at the side, can be universal supports for various types of switches and plugs at the end of the branches of the cable harness.

As a further embodiment, FIG. 2 shows at the edge of the installation plate 2 the upper, first, electrically conductive layer and the lower second electrically conductive layer. In FIG. 1, in the diagrammatic cutaway at the left edge of the installation plate 2, it can be clearly seen how the shorter first screw 61, with its shaft only extends into the first electrically conductive layer and the second longer screw 62 passes through the first electrically conductive layer 21 into the second electrically conductive layer 22. It can be seen that the penetrated upper electrical layer 21, has, as insulation with respect to the shaft of the longer screw 62, a bore that extends down to the lower layer 22.

Alternatively, the longer screw 62 can also have an insulation—not shown here—at the upper portion of the shaft.

### LIST OF REFERENCE CHARACTERS

1 Posts
11 Foot of the post 1
12 Tip of the post 1
2 Installation plate on which the foot 11 can be fixed
21 First electrically conductive layer of the installation plate 2
22 Second electrically conductive layer of the installation plate 2
31 Receptacle, which can be plugged on the tip 12
32 Cable laying aid, which can be plugged on the tip 12
33 Recess on the underside of the receptacle 31 or the underside of the cable laying aid 32.
4 Cable harness supported by cable laying aid 32
5 Functional element on the cable harness 4 supported by receptacle 31
61 First screw for fixing the foot 11 on the installation plate 2, extends only as far as the first electrically conductive layer 21
62 Second screw for fixing the foot 11 on the installation plate 2, longer than the first screw 61, extends as far as the second electrically conductive layer 22

1-28. (canceled)

29. A cable harness production system for producing a cable harness, comprising:
an installation plate; and,
an elongated, substantially vertical post fixed with a foot on said installation plate, said elongated, substantially vertical post having a tip bearing a receptacle, for receiving a functional element, connected to a cable harness, said receptacle being able to be plugged onto said tip with said tip being complementary to a recess on an underside of said receptacle.

30. The cable harness production system for producing a cable harness according to claim 29, wherein said tip has a polygonal profile shape.

31. The cable harness production system for producing a cable harness according to claim 30, wherein said polygonal profile shape of said tip is that of a triangle, a quadrangle or a hexagon, an oval, a circle, a star, a toothed wheel, a cone or a truncated cone.

32. The cable harness production system for producing a cable harness according to claim 29, wherein said tip and said recess are shaped as, and form, a bayonet connection.

33. The cable harness production system for producing a cable harness according to claim 29, wherein in said recess, a clamping screw is arranged approximately perpendicularly to a longitudinal axis of said recess.

34. The cable harness production system for producing a cable harness according to claim 29, wherein said receptacle has a horizontal plate oriented approximately perpendicularly to a longitudinal axis of said recess.

35. The cable harness production system for producing a cable harness according to claim 29, wherein said installation plate has an electrically conductive layer thereon to which said foot is connected, an electrically conductive connection runs through said elongated, substantially vertical post and said tip has a contact producing an electrically conductive connection to a complementary contact in said receptacle.

36. The cable harness production system for producing a cable harness according to claim 29, wherein said elongated, substantially vertical post includes at least one of test device, energy storage means and an energy converter.

37. The cable harness production system for producing a cable harness according to claim 29, further comprising an energy supply for said elongated, substantially vertical post, wherein said installation plate includes a plurality of electrically conductive layers insulated from one another and connected to two poles of an electrical supply voltage, said foot being electrically connected to said plurality of electrically conductive layers.

38. The cable harness production system for producing a cable harness according to claim 37, wherein said elongated, substantially vertical post has means for fastening said vertical post onto said installation plate that includes an electrical connection to said plurality of electrically conductive layers.

39. A cable harness production system for producing a cable harness, comprising:
an installation plate; and,
an elongated, substantially vertical post fixed with a foot on said installation plate, said elongated, substantially vertical post having a tip bearing a cable laying aid for direct guidance of a cable harness, said cable laying aid being able to be plugged onto said tip with said tip being complementary to a recess on an underside of said cable laying aid.

40. The cable harness production system for producing a cable harness according to claim 39, wherein said tip has a polygonal profile shape.

41. The cable harness production system for producing a cable harness according to claim 40, wherein said polygonal profile shape of said tip is that of a triangle, a quadrangle or a hexagon, an oval, a circle, a star, a toothed wheel, a cone or a truncated cone.

42. The cable harness production system for producing a cable harness according to claim 39, wherein said tip and said recess are shaped as, and form, a bayonet connection.

43. The cable harness production system for producing a cable harness according to claim 39, wherein in said recess, a clamping screw is arranged approximately perpendicularly to a longitudinal axis of said recess.

44. The cable harness production system for producing a cable harness according to claim 39, wherein said cable laying aid is a curved section of a channel.

45. The cable harness production system for producing a cable harness according to claim 39, wherein said cable laying aid is one of a cable clip, a cable fastener, a cable clamp, a cable connector, a cable guide, a cable bushing, a conduit, winding tape, a cable gland, a box seal, a pull-through seal and a cable marker.

46. The cable harness production system for producing a cable harness according to claim 39, wherein said elongated, substantially vertical post includes at least one of test device, energy storage means and an energy converter.

47. The cable harness production system for producing a cable harness according to claim 39, further comprising an energy supply for said elongated, substantially vertical post, wherein said installation plate includes a plurality of electrically conductive layers insulated from one another and connected to two poles of an electrical supply voltage, said foot being electrically connected to said plurality of electrically conductive layers.

48. The cable harness production system for producing a cable harness according to claim 47, wherein said elongated, substantially vertical post has means for fastening said vertical post onto said installation plate that includes an electrical connection to said plurality of electrically conductive layers.
